(19) United States
(12) Patent Application Publication
(10) Pub. No.: US 2012/0021299 A1
(43) Pub. Date: Jan. 26, 2012

(54) SOLID LITHIUM ION SECONDARY BATTERY AND ELECTRODE THEREFOR

(75) Inventor: Hideaki MAEDA, Osaka (JP)

(73) Assignee: Samsung Electronics Co., Ltd., Suwon-si (KR)

(21) Appl. No.: 13/167,050

(22) Filed: Jun. 23, 2011

(30) Foreign Application Priority Data
Jul. 26, 2010 (JP) 2010-167039
Sep. 30, 2010 (KR) 10-2010-0095394

(51) Int. Cl. H01M 4/60; H01M 10/0565; H01M 10/0562; H01M 4/62; H01M 10/056

(52) U.S. Cl. 429/317; 429/215; 429/322; 429/320; 429/319

(57) ABSTRACT

A solid lithium ion secondary battery with high safety and high capacity, and an electrode for the solid lithium ion secondary battery. At least one of positive and negative electrodes of the solid lithium ion secondary battery includes a lithium salt of a cyclic imide compound.

### CROSS-REFERENCE TO RELATED APPLICATIONS

This application claims the benefit of Japanese Patent Application No. 2010-167039, filed on Jul. 26, 2010 in the Japanese Patent Office, and Korean Patent Application No. 10-2010-0095394, filed on Sep. 30, 2010 in the Korean Intellectual Property Office, the disclosures of which are incorporated herein by reference.

### BACKGROUND

1. Field

Aspects of the present disclosure relate to a solid lithium ion secondary battery suitable for use as a battery for electric or hybrid electric vehicles or as a large-size storage battery, and to an electrode that may be used with the solid lithium ion secondary battery.

2. Description of the Related Art

Recently, demand for lithium ion secondary batteries has been increasing in various fields, such as in the fields of electric vehicles, hybrid electric vehicles, and large-size storage batteries, due to their high electrochemical capacity, high operating voltage, and good charge and discharge cycle characteristics. Due to the many uses of lithium ion secondary batteries, they are required to have improved stability and higher performance. However, existing lithium ion secondary batteries using nonaqueous electrolyte solutions containing organic solvents in which lithium salts are dissolved have a safety problem in that there may be a risk of fire or explosion at about 150° C. This safety issue has recently brought to attention solid lithium ion secondary batteries that use solid electrolytes capable of conducting lithium ions for improving safety.

In solid lithium ion secondary batteries, their electrodes further contain solid electrolytes in addition to active materials to ensure migration paths for lithium ions (Japanese Patent Publication No. 2010-146936).

However, widely used solid electrolytes consisting of, for example, Li₂S—P₂S₅, are in the form of particles having a particle diameter of 0.1˜20 μm and are large in terms of volume, and thus, the relative amounts of active materials per unit volume used along with solid electrolytes in electrodes may be reduced.

Further, in order to facilitate reactions in a battery, electrodes of the battery are required to have uniform composition. However, a solid electrolyte including a sulfide or an oxide used for an electrode may be difficult to distribute uniformly in a solvent or binder, and thus, hinders an electrode composition from being uniformly coated on a current collector. In addition, certain kinds of solvents or binders in which the solid electrolyte is dispersed may lower conductivity.

### SUMMARY

Aspects of the present invention provide a solid lithium ion secondary battery with high safety and high capacity.

An aspect of the present invention provides a solid lithium ion secondary battery including: a negative electrode including a negative active material that allows intercalation and deintercalation of lithium ions; a positive electrode including a positive active material that allows intercalation and deintercalation of lithium ions; and a solid electrolyte layer interposed between the positive and negative electrodes, wherein at least one of the positive and negative electrodes includes a lithium salt of a cyclic imide compound.

The amount of the lithium salt of the cyclic imide compound in the at least one of the positive and negative electrodes may be from about 1 wt % to about 40 wt %.

The lithium salt of the cyclic imide compound may include at least one compound selected from the group consisting of cyclo-tetrafluoroethane-1,2-bis(sulfonyl)imide lithium ((CF₂SO₂)2NLi) and cyclo-hexafluoropropane-1,3-bis(sulfonyl)imide lithium (CF₂(CF₂SO₂)₂NLi).

The solid electrolyte layer may include a solid electrolyte having a lithium ion conductivity of 10⁻⁴ S/cm or greater.

The lithium salt of the cyclic imide compound in the at least one of the positive and negative electrodes may cover a surface of the corresponding positive or negative active material in the corresponding electrode.

The solid electrolyte may include at least one material selected from the group consisting of Li₃N, lithium super ionic conductors (LISICON), LIPON (Li_{3+y},PO₄₋ₓNₓ), Thio-LISICON (Li_{3.25}Ge_{0.25}P_{0.75}S₄), Li₂S, Li₂S—P₂S₅, Li₂S—SiS₂, Li₂S—GeS₂, Li₂S—B₂S₅, Li₂S—Al₂S₅, Li₂O—Al₂O₃—TiO₂—P₂O₅(LATP), polyethylene oxides, and boric acid ester polymers.

The positive active material may include an oxide or sulfide of a transition metal selected from the group consisting of manganese (Mn), cobalt (Co), nickel (Ni), iron (Fe), and aluminum (Al).

The negative active material may include a material selected from the group consisting of lithium (Li), indium (In), tin (Sn), aluminum (Al), silicon (Si), and alloys thereof; transition metal oxides; and carbonaceous materials.

Another aspect of the present invention provides an electrode for a solid lithium ion secondary battery, the electrode including an electrode active material that allows intercalation and deintercalation of lithium ions, and a lithium salt of a cyclic imide compound.

The amount of the lithium salt of the cyclic imide compound in the electrode may be from about 1 wt % to about 40 wt %.

The lithium salt of the cyclic imide compound may include at least one compound selected from the group consisting of cyclo-tetrafluoroethane-1,2-bis(sulfonyl)imide lithium ((CF₂SO₂)₂NLi) and cyclo-hexafluoropropane-1,3-bis(sulfonypimide lithium (CF₂(CF₂SO₂)₂NLi).

The lithium salt of the cyclic imide compound in the electrode may cover a surface of the electrode active material.

According to an embodiment of the present invention, a solid lithium ion secondary battery includes a positive electrode, a negative electrode, and a solid electrolyte layer interposed between the positive and negative electrodes, wherein at least one of the positive and negative electrodes includes a lithium salt of a cyclic imide compound. According to some embodiments, both the positive electrode and the negative electrode may include lithium salts of cyclic imide compounds. In some embodiments, either the positive electrode or the negative electrode may include a lithium salt of a cyclic imide compound.

In some embodiments, the use of a lithium salt of a cyclic imide compound in an electrode may lead to reduced use of the solid electrolyte in the electrode by an amount equivalent to the amount of the lithium salt of the cyclic imide compound. Lithium salts of cyclic imide compounds are not large in terms of volume, unlike solid electroytes in the form of particles. Thus, if a lithium salt of a cyclic imide compound is added to an electrode composition slurry to replace an amount of the solid electrolyte, a surface of an active material may be coated thinly with the lithium salt of the cyclic imide compound such that sufficient lithium ion conductivity may be attained with the use of a relatively smaller amount of the lithium salt of the cylic imide compound than the solid electrolyte. In addition, the lithium salt of the cyclic imide compound enables the solid electrolyte, a lithium ion conductor, to be more uniformly distributed in the electrode. Thus, the density of the active material may become high in the electrode, and thus the solid lithium ion secondary battery may have a higher capacity per unit volume.

The lithium salt of the cyclic imide compound may have good contact characteristics with respect to the active material, and it may have good coating characteristics when added to the electrode compound slurry so that the electrode composition slurry including the lithium salt of the cyclic imide compound may be thinly coated to form a thin sheet on the current collector.

An amount of the lithium salt of the cyclic imide compound in at least one of the positive and negative electrodes may be from about 1 wt % to about 40 wt %.

Suitable lithium salts of cyclic imide compounds may include cyclo-tetrafluoroethane-1,2-bis(sulfonyl)imide lithium ((CF₂SO₂)₂NLi), cyclo-hexafluoropropane-1,3-bis(sulfonyl)imide lithium (CF₂(CF₂SO₂)₂NLi), and the like.

A suitable solid electrolyte of the solid electrolyte layer may have a lithium ion conductivity of about 10⁻⁴ S/cm or greater.

Additional aspects and/or advantages of the invention will be set forth in part in the description which follows and, in part, will be apparent from the description, or may be learned by practice of the presented embodiments.

### BRIEF DESCRIPTION OF THE DRAWINGS

These and/or other aspects and advantages of the invention will become apparent and more readily appreciated from the following description of the embodiments, taken in conjunction with the accompanying drawings, of which:

FIG. 1 illustrates an existing electrode (a) and an electrode (b) according to an embodiment of the present invention; and

FIG. 2 is a schematic view illustrating a structure of a solid lithium ion secondary battery as manufactured in the Examples.

### DETAILED DESCRIPTION

Reference will now be made in detail to the present embodiments of the present invention, examples of which are illustrated in the accompanying drawings, wherein like reference numerals refer to like elements throughout. The embodiments are described below in order to explain the present invention by referring to the figures.

According to embodiments of the present invention, a solid lithium ion secondary battery includes a positive electrode, a negative electrode, and a solid electrolyte layer interposed between the positive electrode and the negative electrode. At least one of the positive and negative electrodes contains a lithium salt of a cyclic imide compound.

In some embodiments the lithium salt of the cyclic imide compound may be a compound selected from among compounds represented by Formulae (1) to (4) below. These lithium salts of cyclic imide compounds may be used individually or in combination of at least two thereof:

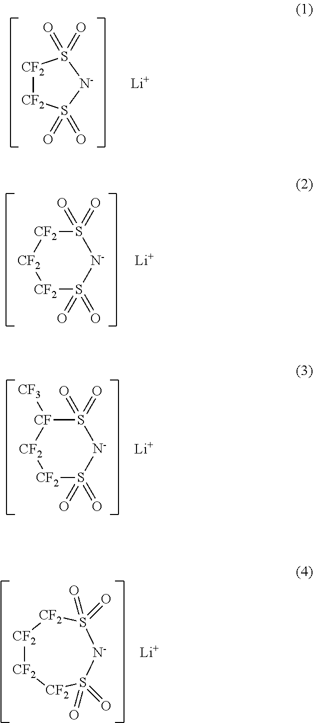

In some embodiments suitable lithium salts of cyclic imide compounds include cyclo-tetrafluoroethane-1,2-bis(sulfonyl)imide lithium represented by Formula 1, having a five-membered cyclic structure, and cyclo-hexafluoropropane-1,3-bis(sulfonyl)imide lithium represented by Formula (2), having a six-membered cyclic structure. These lithium salts of cyclic imide compounds may exhibit stable lithium ion conductivity in high voltage environments near about 4V.

Existing lithium ion secondary batteries using non-aqueous electrolyte solutions may often include polyimide polymers as binders; however, they cannot use lithium salts of cyclic imide compounds according to embodiments of the present invention as binders, because these lithium salts of cyclic imide compounds are soluble in organic solvents. Accordingly, the lithium salts of cyclic imide compounds used in embodiments of the present invention cannot be used as binders in existing lithium ion secondary batteries using non-aqueous electrolyte solutions.

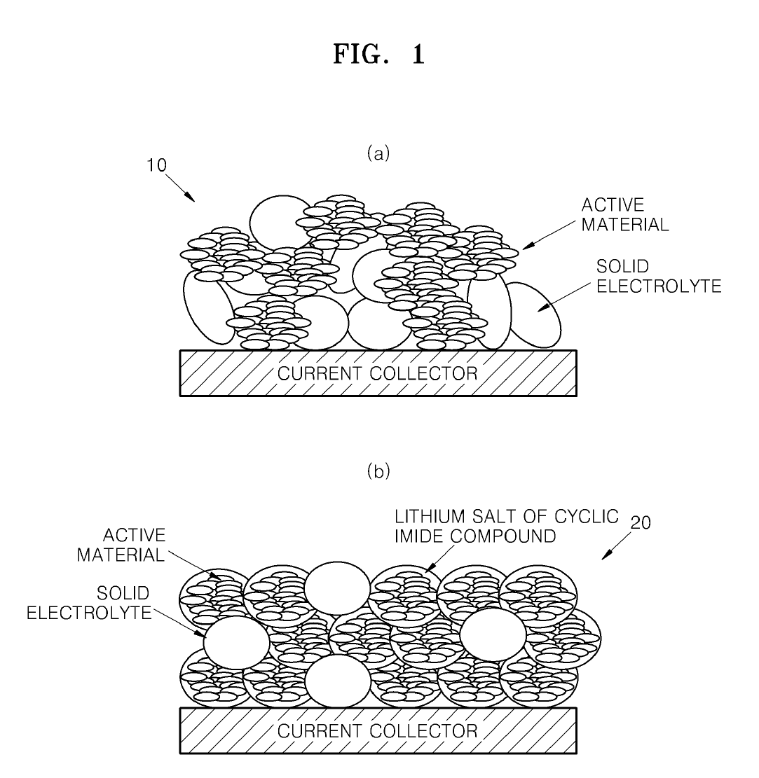

FIG. 1 (a) illustrates an existing electrode 10 including only a solid electrolyte as a lithium ion conductor. The solid electrolyte in the existing electrode 10 is in the form of particles and is large in terms of volume, and thus density of an active material in the electrode 10 is low. Thus, a solid lithium ion secondary battery including the electrode 10 has low capacity per unit volume.

In contrast, an electrode 20 according to an embodiment of the present invention uses a lithium salt of a cyclic imide compound as a lithium ion conductor, wherein a surface of an active material is coated thinly with the lithium salt of the cyclic imide compound, as illustrated in (b) of FIG. 1. The addition of the lithium salt of the cyclic imide compound into the electrode 20 enables a solid electrolyte to be used in about 5 wt % to about 10 wt % that is much less than about 40 wt % of the solid electrolyte used in existing electrodes, such as existing electrode 10. Furthermore, the added amount of the solid electrolyte may be zero according to a structure or conditions of use of the battery. Thus, in some embodiments of the present invention the density of the active material in the electrode may be improved, thereby enabling formation of a solid lithium ion secondary battery having higher capacity per volume. A coating layer of the lithium salt of the cyclic imide compound on the surface of the active material may have irregular thicknesses, or may be in the form of discontinuous dots.

In some embodiments the active material in (b) of FIG. 1 may include secondary particles (having a median particle diameter of about 5 μm to about 20 μm) agglomerated from primary particles (having a particle diameter of about 0.1 μm to about 1 μm). The solid electrolyte in (b) of FIG. 1 may have a particle diameter of about 0.1 μm to about 20 μm.

In at least one of the positive and negative electrodes the amount of the lithium salt of the cyclic imide compound may be from about 1 wt % to about 40 wt %, and in some embodiments, from about 5wt % to about 20 wt %, and in some other embodiments, from about 5 wt % to about 10 wt %. If the amount of the lithium salt of the cyclic imide compound is too small, it may be insufficient to reduce the added amount of the solid electrolyte and attain sufficient capacity per unit volume. On the other hand, if the amount of the lithium salt of the cyclic imide compound too large, rate characteristics of the solid lithium ion secondary battery may deteriorate.

The positive electrode and negative electrode respectively include positive and negative active materials, in addition to the lithium salt of the cyclic imide compound. Any suitable positive active material that allows intercalation and deintercalation of lithium ions may be used. Suitable positive active materials include transition metal-containing oxides and sulfides, wherein the transition metals may include manganese (Mn), cobalt (Co), nickel (Ni), iron (Fe), and aluminum (Al). In some embodiments, suitable positive active materials include LiMn₂O₄, LiCoO₂, LiNiO₂, LiFeO₂, LiNi_{1/3}Co_{1/3}Mn_{1/3}O₂, LiNi_{0.8}Co_{0.2}O₂, and LiNi_{0.8}CoO_{0.15}Al_{0.05}O₂. These positive active materials may be used individually or in a combination of at least two thereof.

Any suitable negative active material that is alloyable with lithium or may allow intercalation and deintercalation of lithium ions may be used. Suitable negative active materials include metals or metalloids, such as lithium (Li), indium (In), tin (Sn), aluminum (Al), and silicon (Si), and alloys thereof; transition metal oxides, such as Li_{4/3}Ti_{5/3}O₄, and SnO; and carbonaceous materials, such as artificial graphite, graphite carbon fibers, resin-sintered carbon, carbon grown by vapor-phase thermal decomposition, cokes, mesophase carbon microbeads (MCMB), furfuryl alcohol resin-sintered carbon, polyacene, pitch-based carbon fibers (PCF), vapor grown carbon fibers, natural graphite, hard carbon, and the like. These negative active materials may be used individually or in a combination of at least two thereof.

The positive and negative electrodes may include mixtures of either the positive or negative active materials in powder form, for example, with electrically conducting agents, binders, fillers, dispersing agents, and ion conductors in appropriate ratios.

Suitable electrically conducting agents include graphite, carbon black; acetylene black, ketjen black, carbon fibers, metal powders, and the like. Suitable binders include polytetrafluoroethylene, polyfluorovinylidene, polyethylene, polypropylene and the like. The positive and negative electrodes may further include solid electrolytes that will be described later, respectively, if required.

The positive and negative electrodes may be manufactured as follows. In some embodiments, mixtures of active materials, a lithium salt of a cyclic imide compound, and various additives, as described above are prepared. Then, the mixtures are respectively compressed into pellets to have high densities by using a hydraulic press, thereby manufacturing the positive and negative electrodes. In some embodiments, the mixtures prepared as described above are added to solvents, for example, water or organic solvents, to obtain slurries or pastes for manufacturing the positive and negative electrodes. Then, these slurries or pastes are respectively coated on current collectors by using, for example, a doctor blade method, are dried, and are then densified by using, for example, rolling rolls, thereby manufacturing the positive and negative electrodes.

Suitable current collectors include plates or sheets made of indium (In), copper (Cu), magnesium (Mg), stainless steel, titanium (Ti), iron (Fe), cobalt (Co), nickel (Ni), zinc (Zn), aluminum (Al), germanium (Ge), lithium (Li), or an alloy thereof.

If a metal or a metal alloy is selected as the negative active material, a metal sheet or a metal alloy sheet may be readily used as the negative electrode without using a current collector.

The solid electrolyte layer may include a lithium ion conductor as a solid electrolyte, wherein the lithium ion conductor may include an inorganic compound, an organic compound, or a composite material thereof.

Any suitable inorganic compound may be used. Suitable inorganic compounds include Li₃N, lithium super ionic conductors (LISICON), LIPON(Li_{3+y}PO₄₋ₓNₓ), Thio-LISICON(Li_{3.25}Ge_{0.25}P_{0.75}S₄), Li₂S, Li₂S—P₂S₅, Li₂S—SiS₂, Li₂S—GeS₂, Li₂S—B₂S₅, Li₂S—Al₂S₅, Li₂O—Al₂O₃—TiO₂—P₂O₅(LATP), and the like. These inorganic compounds may have crystalline, amorphous, glass, or glass ceramic structures.

Any suitable organic compound may be used. Suitable organic compounds include polyethylene oxide (PEO), boric acid ester polymers, and the like.

Any suitable inorganic-organic composite material may be used. A suitable inorganic-organic composite material may be a composite of Li₂S—P₂S₅, which is an inorganic solid electrolyte, and polyethylene oxide, which is an organic solid electrolyte.

The solid electrolyte may have a lithium ion conductivity of 10⁻⁴ S/cm or greater, and in some embodiments, may be amorphous Li₂S—P₂S₅, which has a lithium ion conductivity of 10⁻⁴ S/cm or greater.

In some embodiments, a solid lithium ion secondary battery may be manufactured by stacking a positive electrode, a solid electrolyte layer, and a negative electrode, which are prepared as described above, to form a stack, and then pressing the stack. In some embodiments, a solid lithium ion secondary battery may be manufactured by depositing or coating materials (compositions) for forming a positive electrode, a solid electrolyte layer, and a negative electrode and then pressing the resultant structure.

### EXAMPLES

The disclosed embodiments will be described in further detail with reference to the following examples. The following examples are for illustrative purposes only and are not intended to limit the scope of the invention.

### Example 1

A positive active material LiNi_{0.8}Co_{0.15}Al_{0.05}O₂, a sulfide solid electrolyte Li₂S—P₂S₅(80-20 mol %), a lithium salt of a six-membered cyclic imide compound CF₂(CF₂SO₂)₂NLi, and an electrically conducting agent, vapor-grown carbon fibers (VGCF), were mixed in a weight ratio of 80:5:10:5, and were then dispersed in toluene to prepare a positive electrode slurry. The positive electrode slurry was coated on a stainless steel sheet by using a doctor blade, and was then dried at about 110° C. to obtain a positive electrode. A negative electrode slurry was prepared in the same manner as the active electrode slurry, except that graphite was used as a negative active material, and was then coated on a stainless steel sheet to obtain a negative electrode.

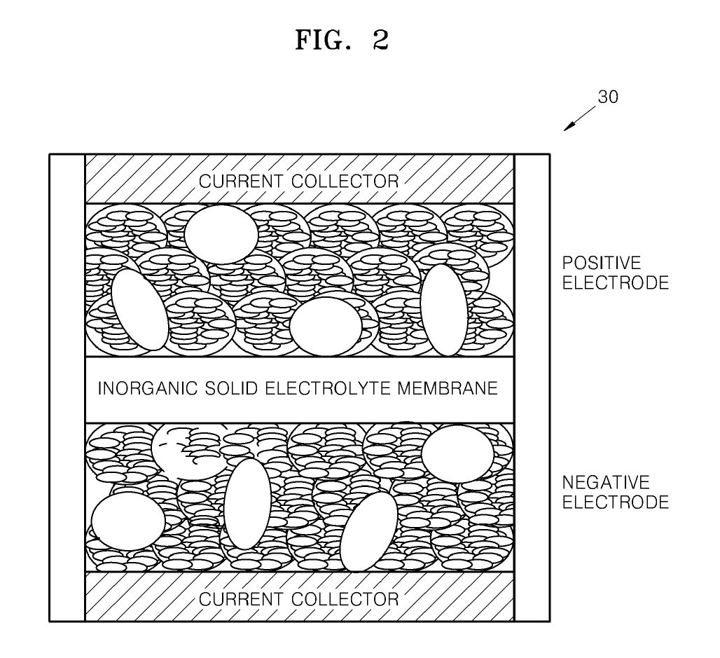

The positive and negative electrodes were punched into circular pieces each having a diameter of 13 mm. Then, a sulfide solid electrolyte layer Li₂S—P₂S₅ (80-20 mol %) was placed between the positive and negative electrodes, and then the combination was pressed at a pressure of 4 t/cm²to form a layer electrode assembly, which was then encased by applying a pressure using a torque wrench, thereby completing the manufacture of a solid lithium ion secondary battery 30 as illustrated in FIG. 2. The solid electrolyte Li₂S—P₂S₅ (80-20 mol %) had a lithium ion conductivity of about 3×10⁻⁴ S/cm.

### Example 2

A solid lithium ion secondary battery 30 was manufactured in the same manner as in Example 1, except that the positive and negative active material slurries were prepared in a weight ratio of 60:25:10:5.

### Example 3

A solid lithium ion secondary battery 30 was manufactured in the same manner as in Example 1, except that the positive and negative active material slurries were prepared in a weight ratio of 70:10:15:5 and a weight ratio of 60:25:10:5 respectively.

### Example 4

A solid lithium ion secondary battery 30 was manufactured in the same manner as in Example 1, except that the positive and negative active material slurries were prepared in a weight ratio of 60:0:35:5 such that no solid electrolyte was included in the positive and negative electrodes.

### Example 5

A solid lithium ion secondary battery 30 was manufactured in the same manner as in Example 1, except that LiCoO₂ was used as a positive active material, and the positive and negative active material slurries were prepared in a weight ratio of 60:25:10:5.

### Example 6

A solid lithium ion secondary battery 30 was manufactured in the same manner as in Example 1, except that LiMn₂O₄ was used as a positive active material, and the positive and negative active material slurries were prepared in a weight ratio of 60:25:10:5.

### Example 7

A solid lithium ion secondary battery 30 was manufactured in the same manner as in Example 1, except that (CF₂SO₂)₂NLi having a five-membered cyclic structure was used as a lithium salt of a cyclic imide compound.

### Comparative Example 1

A solid lithium ion secondary battery was manufactured in the same manner as in Example 1, except that the positive and negative active material slurries were prepared in a weight ratio of 80:0:0:20, without adding a solid electrolyte and a lithium salt of a cylic imide compound to manufacture positive and negative electrodes.

### Comparative Example 2

A solid lithium ion secondary battery was manufactured in the same manner as in Example 1, except that the positive and negative active material slurries were prepared in a weight ratio of 80:15:0:5, without adding a lithium salt of the cyclic imide compound to manufacture positive and negative electrodes.

### Comparative Example 3

A solid lithium ion secondary battery was manufactured in the same manner as in Example 1, except that LiCoO₂was used as a positive active material, and the positive and negative active material slurries were prepared in a weight ratio of 60:35:0:5, without adding a lithium salt of a cyclic imide compound to manufacture positive and negative electrodes.

### Comparative Example 4

A solid lithium ion secondary battery was manufactured in the same manner as in Example 1, except that LiCoO₂ was used as a positive active material, and the positive and negative active material slurries were prepared in a weight ratio of 80:15:0:5, without adding a lithium salt of a cyclic imide compound to manufacture positive and negative electrodes.

### Comparative Example 5

A solid lithium ion secondary battery was manufactured in the same manner as in Example 1, except that LiMn₂O₄ was used as a positive active material, and the positive and negative active material slurries were prepared in a weight ratio of 60:35:0:5, without adding a lithium salt of a cyclic imide compound to manufacture positive and negative electrodes.

### (Performance test)

Solid lithium ion secondary batteries of the Examples and Comparative Examples were repeatedly charged and discharged at a voltage range of about 4.2 V to about 2.5 V at a current density of 20 μA/cm² (initial capacity) to measure capacities. Capacity at 1 C discharge rate was set to be a capacity at a current density of 1.1 mA/cm². Rate characteristics of these solid lithium ion secondary batteries were measured and expressed as percentages (%) with respect to 1 C capacity of the solid lithium ion secondary battery of Example 1. The results are shown in Table 1 below.

TABLE 1

| | | | | Active material: | | | |
|---|---|---|---|---|---|---|---|
| | | | | Electrolyte:Imide: | | | |
| | | | | Electrically conducting | | | |
| | | Active material | | agent (wt %) | | Volume | Rate |
| | | Positive | Negative | Positive | Negative | Capacity | Characteristics |
| | | electrode | electrode | electrode | electrode | (mAh/mL) | (%) |
| Example | 1 | LiNi_{0.8}Co_{0.15}Al_{0.05}O₂ | Graphite | 80:5:10:5 | 80:5:10:5 | 17.60 | 100 |
| | 2 | LiNi_{0.8}Co_{0.15}Al_{0.05}O₂ | Graphite | 60:25:10:5 | 60:25:10:5 | 13.20 | 115 |
| | 3 | LiNi_{0.8}Co_{0.15}Al_{0.05}O₂ | Graphite | 70:10:15:5 | 60:25:10:5 | 15.40 | 94 |
| | 4 | LiNi_{0.8}Co_{0.15}Al_{0.05}O₂ | Graphite | 60:0:35:5 | 60:0:35:5 | 15.80 | 86 |
| | 5 | LiCoO₂ | Graphite | 60:25:10:5 | 60:25:10:5 | 8.80 | 105 |
| | 6 | LiMn₂O₄ | Graphite | 60:25:10:5 | 60:25:10:5 | 5.03 | 82 |
| | 7 | LiNi_{0.8}Co_{0.15}Al_{0.05}O₂ | Graphite | 80:5:10:5 | 80:5:10:5 | 17.50 | 96 |
| Comparative | 1 | LiNi_{0.8}Co_{0.15}Al_{0.05}O₂ | Graphite | 80:0:0:20 | 80:0:0:20 | 0.75 | 0.5 |
| Example | 2 | LiNi_{0.8}Co_{0.15}Al_{0.05}O₂ | Graphite | 80:15:0:5 | 80:15:0:5 | 6.70 | 120 |
| | 3 | LiCoO₂ | Graphite | 60:35:0:5 | 60:35:0:5 | 5.90 | 135 |
| | 4 | LiCoO₂ | Graphite | 80:15:0:5 | 80:15:0:5 | 4.20 | 41 |
| | 5 | LiMn₂O₄ | Graphite | 60:35:0:5 | 60:35:0:5 | 2.81 | 26 |

Referring to Table 1, the solid lithium ion secondary batteries 30 of Examples 1 to 7 that include the lithium salts of cyclic imide compounds in their electrodes are found to have good capacities per volume and good rate characteristics. The solid lithium ion secondary battery of Example 4 that does not contain a solid electrolyte in their electrodes has a capacity per volume and rate characteristics that are good enough for practical use. In contrast, the solid lithium ion secondary batteries of Comparative Examples 1 to 5 that do not contain a lithium salt of a cyclic imide compound in their electrodes have lower capacities per volume than the solid lithium ion secondary batteries of those examples in which the same kinds and same amounts of active materials as used in Comparafive Examples 1 to 5.

As described above, according to the one or more of the above embodiments of the present invention, a solid lithium ion secondary battery may include a reduced amount of a solid electrolyte in at least one of the electrodes thereof to have a higher active material density in the electrode, and thus may have a higher capacity per volume. Furthermore, consistent reactions may occur throughout the electrode. Thus, the solid lithium ion secondary battery may have high safety and high capacity.

It should be understood that the exemplary embodiments described herein should be considered in a descriptive sense only and not for purposes of limitation. Descriptions of features or aspects within each embodiment should typically be considered as available for other similar features or aspects in other embodiments.

Although a few embodiments of the present invention have been shown and described, it would be appreciated by those skilled in the art that changes may be made in these embodiments without departing from the principles and spirit of the invention, the scope of which is defined in the claims and their equivalents.

What is claimed is:

1. A solid lithium ion secondary battery comprising:
a negative electrode including a negative active material that allows intercalation and deintercalation of lithium ions;
a positive electrode including a positive active material that allows intercalation and deintercalation of lithium ions; and
a solid electrolyte layer interposed between the positive and negative electrodes, wherein at least one of the positive and negative electrodes includes a lithium salt of a cyclic imide compound.

2. The solid lithium ion secondary battery of claim 1, wherein the amount of the lithium salt of the cyclic imide compound in the at least one of the positive and negative electrodes is from about 1 wt % to about 40 wt %.

3. The solid lithium ion secondary battery of claim 1, wherein the lithium salt of the cyclic imide compound comprises at least one compound selected from the group consisting of cyclo-tetrafluoroethane-1,2-bis(sulfonyl)imide lithium((CF₂SO₂)₂NLi) and cyclo-hexafluoropropane-1,3-bis(sulfonyl)imide lithium(CF₂(CF₂SO₂)₂NLi).

4. The solid lithium ion secondary battery of claim 1, wherein the solid electrolyte layer comprises a solid electrolyte having a lithium ion conductivity of 10⁻⁴ S/cm or greater.

5. The solid lithium ion secondary battery of claim 1, wherein the lithium salt of the cyclic imide compound in the at least one of the positive and negative electrodes covers a surface of the corresponding positive or negative active material in the corresponding electrode.

6. The solid lithium ion secondary battery of claim 1, wherein the solid electrolyte comprises at least one material selected from the group consisting of Li₃N, lithium super ionic conductors (LISICON), LIPON (Li_{3+y}PO₄₋ₓNₓ), Thio-LISICON (Li_{3.25}Ge_{0.25}P_{0.75}S₄), Li₂S, Li₂S—P₂S₅, Li₂S—SiS₂, Li₂S—GeS₂, Li₂S—B₂S₅, Li₂S—Al₂S₅, Li₂O—Al₂O₃—TiO₂—P₂O₅ (LATP), polyethylene oxides, and boric acid ester polymers.

7. The solid lithium ion secondary battery of claim 1, wherein the positive active material comprises an oxide or sulfide of a transition metal selected from the group consisting of manganese (Mn), cobalt (Co), nickel (Ni), iron (Fe), and aluminum (Al).

8. The solid lithium ion secondary battery of claim 1, wherein the negative active material comprises a material selected from the group consisting of lithium (Li), indium (In), tin (Sn), aluminum (Al), silicon (Si), and alloys thereof; transition metal oxides; and carbonaceous materials.

9. The solid lithium ion secondary battery of claim 1, wherein the positive and negative electrodes further comprise at least one additive selected from the group consisting of an electrically conducting agent, a binder, a filler, a dispersing agent, and an ion conductor.

10. The solid lithium ion secondary battery of claim 9, wherein the electrically conducting agent comprises at least one of graphite, carbon black, acetylene black, ketjen black, carbon fiber, metal powders, and any mixtures of the foregoing.

11. The solid lithium ion secondary battery of claim 9, wherein the binder comprises at least one of polytetrafluoroethylene, polyfluorovinylidene, polyethylene, polypropylene and any mixtures of the foregoing.

12. An electrode for a solid lithium ion secondary battery, the electrode comprising:
an electrode active material that allows intercalation and deintercalation of lithium ions; and
a lithium salt of a cyclic imide compound.

13. The electrode of claim 12, wherein the amount of the lithium salt of the cyclic imide compound in the electrode is from about 1 wt % to about 40 wt %.

14. The electrode of claim 12, wherein the lithium salt of the cyclic imide compound comprises at least one selected from the group consisting of cyclo-tetrafluoroethane-1,2-bis(sulfonyl)imide lithium((CF₂SO₂)₂NLi) and cyclo-hexafluoropropane-1,3-bis(sulfonyl)imide lithium(CF₂(CF₂SO₂)₂NLi).

15. The electrode of claim 12, wherein the lithium salt of the cyclic imide compound in the electrode covers a surface of the electrode active material.

16. The electrode of claim 12, wherein the electrode active material comprises an oxide or sulfide of a transition metal selected from the group consisting of manganese (Mn), cobalt (Co), nickel (Ni), iron (Fe), and aluminum (Al).

17. The electrode of claim 12, wherein the electrode active material comprises a material selected from the group consisting of lithium (Li), indium (In), tin (Sn), aluminum (Al), silicon (Si), and alloys thereof; transition metal oxides; and carbonaceous materials.

18. The electrode of claim 12, wherein the positive and negative electrodes further comprise at least one additive selected from the group consisting of an electrically conducting agent, a binder, a filler, a dispersing agent, and an ion conductor.

19. The electrode of claim 18, wherein the electrically conducting agent comprises at least one of graphite, carbon black, acetylene black, ketjen black, carbon fiber, metal powders, and any mixtures of the foregoing.

20. The electrode of claim 18, wherein the binder comprises at least one of polytetrafluoroethylene, polyfluorovinylidene, polyethylene, polypropylene and any mixtures of the foregoing.
